(19) United States
(12) Patent Application Publication
(10) Pub. No.: US 2009/0204611 A1
(43) Pub. Date: Aug. 13, 2009

(54) INFORMATION DISPLAY APPARATUS, INFORMATION DISPLAY PROGRAM AND INFORMATION DISPLAY SYSTEM

(75) Inventors: Tomihisa Kamada, Tokyo (JP); Hiroyuki Suzuki, Kanagawa (JP); Fumio Kawabata, Saitama (JP)

Correspondence Address: MORRISON & FOERSTER LLP, 425 MARKET STREET, SAN FRANCISCO, CA, 94105-2482, US

(73) Assignee: Access Co., Ltd., TOKYO (JP)

(21) Appl. No.: 12/439,040

(22) PCT Filed: Aug. 24, 2007
(86) PCT No.: PCT/JP2007/000904

§ 371 Date: Feb. 26, 2009

(30) Foreign Application Priority Data
Aug. 29, 2006 (JP) 2006-232860

(51) Int. Cl. G06F 17/30

(52) U.S. Cl. 707/5; 707/E17.01

(57) ABSTRACT

The interest of a user of an information terminal is extracted by a file operation and information suited to the interest is provided. When a system call for file access is issued from an application program, an access processor 104 selects from a file storage unit 102 a file designated by the system call, and then performs the file access. A phrase extractor 106 extracts a plurality of phrases from the file in accordance with a predetermined extraction rule. Those of the keywords stored in a keyword storage unit 110 that match the extracted phrases are selected. A score processor 120 assigns to the selected keyword a weight suited to the situation of access to the file by the access processor 104.<br></br> An information selector 150 receives the weighted keyword and determines a prioritized keyword. Useful information corresponding to the priority keyword is selected from a useful information storage unit 130 and displayed on a display of an information terminal.

### TECHNICAL FIELD

The present invention relates to a technology which monitors the operation of an application program and displays to a user information relevant to a file handled by the application.

### BACKGROUND ART

Web services are provided in which keywords or texts input or viewed by the user via a browser are referred to so that useful information, such as advertisements or web pages, that may be of interest to the user, are presented to the browser. For example, in a web searching site as shown in non-patent document 1, the user's input of a search keyword will display an advertisement relevant to the keyword in a browser along with the results of searching sites. In a web mail service as shown in non-patent document 2, a text advertisement and a link to a web page of high relevance to a mail message are displayed beside the mail message.

Non Patent Citation 1: Advertise your business on Google, [online], [retrieved on 2006 Aug. 25], Internet <URL:https://adwords.google.com/select/Login>
Non Patent Citation 2: About Gmail, [online], [retrieved on 2006 Aug. 25], Internet <URL:http://mail.google.com/mail/help/more.html#ads>

### DISCLOSURE OF INVENTION

### Technical Problem

In the web services shown in the above-mentioned non-patent documents 1 and 2, useful information, relevant to the keyword which the user inputted at the web searching site at that time, or the keyword contained in the mail message being viewed by the user in the web mail service, is presented. The history of keyword searches or email viewing by the same user is not reflected in the current useful information. Therefore, useful information less interesting to the user is in fact presented in many cases.

In this background, a general purpose of the present invention is to provide a technology for monitoring the situation of file access by an application program, and providing the user with useful information relevant to the accessed file.

### Technical Solution

One embodiment of the present invention relates to an information display apparatus. The apparatus comprises: a file storage unit which stores a plurality of files; an access processor which, when a system call for file access is issued by one of a plurality of application programs, selects a file designated by the system call as a target of the file access from the file storage unit, and processes the file access designated by the system call; a keyword storage unit which stores a plurality of keywords; a phrase extractor which extracts a plurality of phrases from the file subjected to the file access, in accordance with a predetermined extraction rule; a score processor which weights a keyword that matches a phrase extracted from the file subjected to the file access, in accordance with the situation of access by the access processor to the file, and records the weighted keyword in the keyword storage unit; a useful information storage unit which stores a plurality of items of useful information to be presented to the user, in association with keywords relevant to the content of the useful information; and an information selector which, when a plurality of phrases are extracted from the file subjected to the file access, refers to weights recorded in association with keywords that match the plurality of phrases, and selects and displays on a screen useful information associated with a keyword prioritized by a weight.

The term “useful information” in this case refers to information which creates certain value for the user of a device. According to this embodiment, keywords are weighted in response to a system call for file access from an application program, according to the situation of access to a file, and a user is shown useful information corresponding to the keyword prioritized by the assigned weight. Accordingly, useful information of high relevance to the file being currently processed by the application program initiated by the user can be displayed without the intervention of the application program. By using a system call from the application program, information related to keywords can be collected from a variety of files, regardless of the type of application program. Therefore, accuracy in presenting useful information that matches the user's interest is increased.

The score processor may determine the weight according to the frequency of access to the file by the access processor. Phrases that are included in frequently accessed files are considered to be of importance to the user. Thus, by assigning a larger weight with an increase in the frequency of access to a file, it is ensured that weighted keywords are more likely to be selected by the information selector. This allows useful information associated with important keywords to be presented to the user.

The score processor may determine the weight according to the type of access to the file by the access processor. The term “type of access” refers to processes such as opening and closing, rewriting and deleting of files. For example, a file simply viewed by the user and a file updated for storage are considered to be of different importance to the user. By assigning a weight to keywords in accordance with the type of access to a file, it is ensured that useful information associated with important keywords are presented to the user.

The score processor may decrease the weight assigned to a keyword with the passage of time. If the weight assigned to a keyword increases permanently, those keywords that appear in files frequently used recently will not be prioritized unless the weight thereof exceeds the weight assigned to keywords that have been prioritized, with the result that the same useful information continues to be presented. By decreasing the weight assigned by the score processor to a keyword with the passage of time, contribution from the weight assigned in the past is reduced so that useful information associated with keywords included in recently accessed files are more likely to be presented. In other words, keywords prioritized by the information selector according to their weight are prevented from being fixed.

The information selector may make adjustment so that the keyword to which a weight equal to or larger than a predetermined value is continuously assigned for a prescribed period of time or longer is further prioritized. As mentioned above, files that are frequently used recently are considered to be currently important to the user. In this respect, keywords that have collected a predetermined weight or larger in a predetermined period of time are dealt with as “staple” keywords and are selected by the information selector in preference to other keywords. In this way, more proper useful information suited to the current tendency of operation by the user is displayed.

The information selector may inquire of the user whether adjustment should be applied, and allows adjustment to be performed only when an affirmative reply is received. The aforementioned adjustment of the priority of keywords may be felt by some users as being troublesome. In this respect, by inquiring of the user whether the aforementioned adjustment should be applied, presentation can be made more suited to the interest of the user.

The score processor may determine the weight according to the type of file accessed by the access processor. The importance of a file to the user may differ depending on the type of file accessed (e.g., HTML file or document file). In this respect, it may be useful to change the weight depending on the file type.

Another embodiment of the present invention relates to an information presenting apparatus. The apparatus comprises: a file storage unit which stores a plurality of files; a keyword storage unit which stores a plurality of keywords; a phrase extractor which, when a system call for file access is issued by one of a plurality of application programs, extracts a plurality of phrases from the file subjected to the file access, in accordance with a predetermined extraction rule; a score processor which weights a keyword that matches a phrase extracted from the file subjected to the file access, in accordance with the type of the file, and records the weighted keyword in the keyword storage unit; a useful information storage unit which stores a plurality of items of useful information to be presented to the user, in association with keywords relevant to the content of the useful information; and an information selector which, when a plurality of phrases are extracted from the file subjected to the file access, refers to weights recorded in association with keywords that match the plurality of phrases, and selects and displays on a screen useful information associated with a keyword prioritized by a weight.

According to this embodiment, keywords are weighted according to the type of file accessed by the access processor, in response to a system call for file access from an application program. Useful information corresponding to the keyword prioritized by the weight assigned thereto is presented to the user. By assigning a large weight to keywords included in a specific type of file (e.g., an HTML file) than those included in files of the other types, useful information highly relevant to files of interest to the user can be displayed.

Another embodiment of the present invention relates to a server-client system for displaying useful information in a client terminal. The client terminal comprises the file storage unit, the access processor, the keyword storage unit, the phrase extractor, and the score processor as mentioned above. Moreover, the client terminal comprises an information selector which, when a plurality of phrases are extracted from the file subjected to the file access, refers to weights recorded in association with keywords that match the plurality of phrases, determines a keyword prioritized by the weight, and transmits the determines keyword to the server. The server comprises: a useful information storage unit which stores a plurality of items of useful information to be presented to the user, in association with keywords relevant to the content of the useful information, wherein the server selects the useful information corresponding to the keyword received from the client terminal from the useful information storage unit, and transmits the selected useful information to the client terminal. According to this embodiment, the useful information storage unit resides on the server side so that updating, addition and deletion of useful information and change in correspondence between useful information and keywords can be performed more efficiently than in the case in which the useful information storage unit resides in the client terminal.

Another embodiment of the present invention also relates to a server-client system for displaying useful information in a client terminal. The client terminal comprises the file storage unit, the access processor, the keyword storage unit, the phrase extractor, and the score processor as mentioned above. The score processor transmits the weighted keyword to the server. In addition to the useful information storage unit, the server comprises an information selector which receives the weighted keyword from the client terminal, selects the useful information corresponding to the keyword prioritized by the weight, and transmits the selected useful information to the client terminal. According to this embodiment, useful information can be updated, added, deleted efficiently, and correspondence between useful information and keywords can be changed efficiently.

Optional combinations of the aforementioned constituting elements, and implementations of the invention in the form of methods, apparatuses, systems, recording mediums and computer programs may also be practiced as additional modes of the present invention.

### Advantageous Effects

According to at least one aspect of the present invention, the status of access to a file by an application program is monitored and information related to the file accessed is presented to the user.

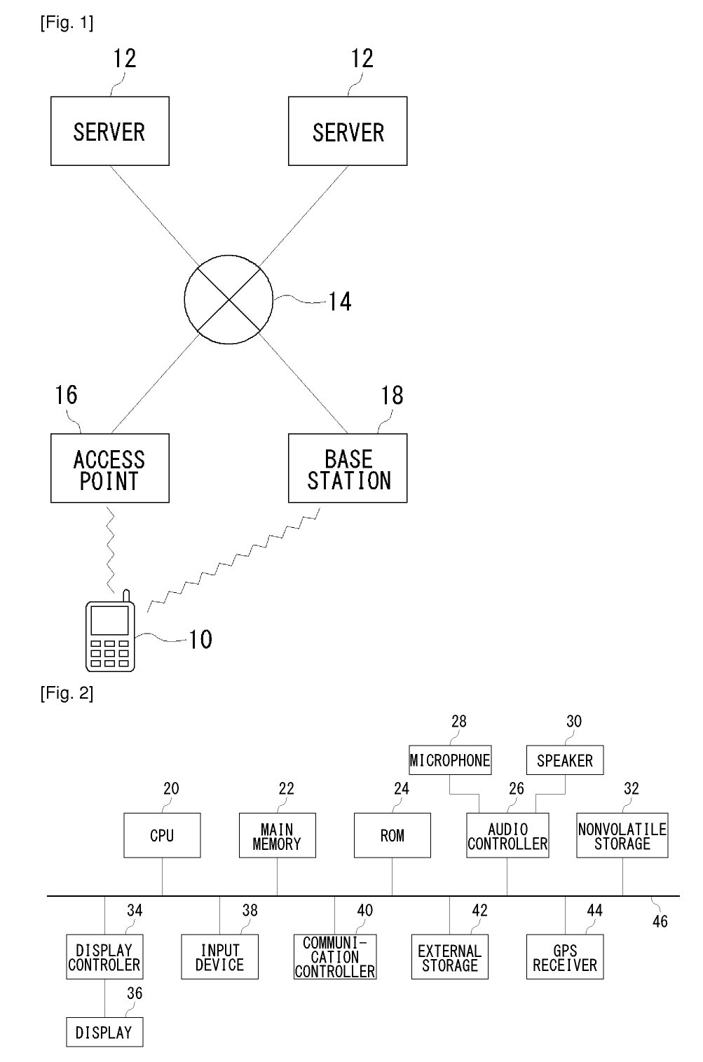

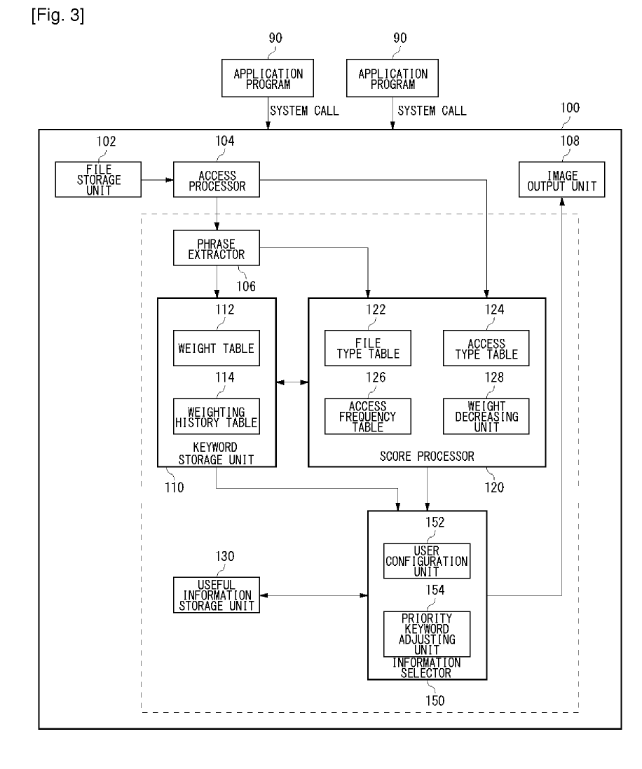

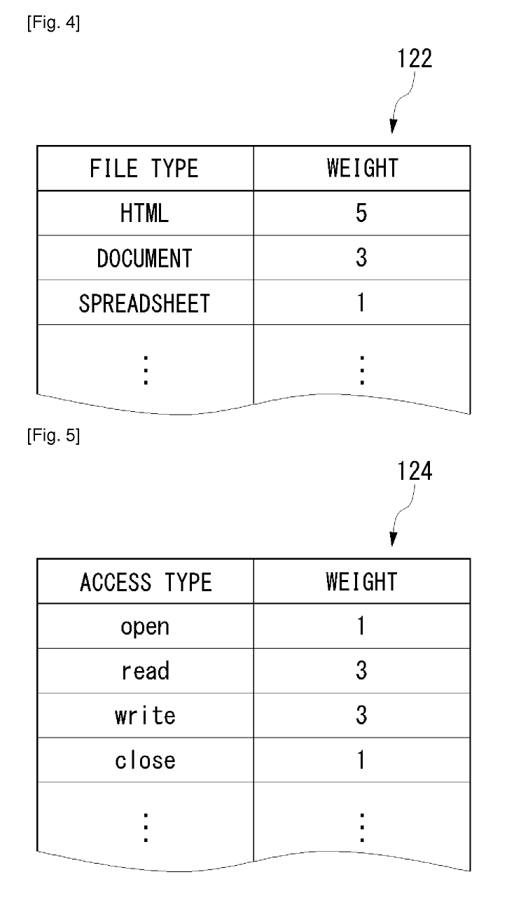

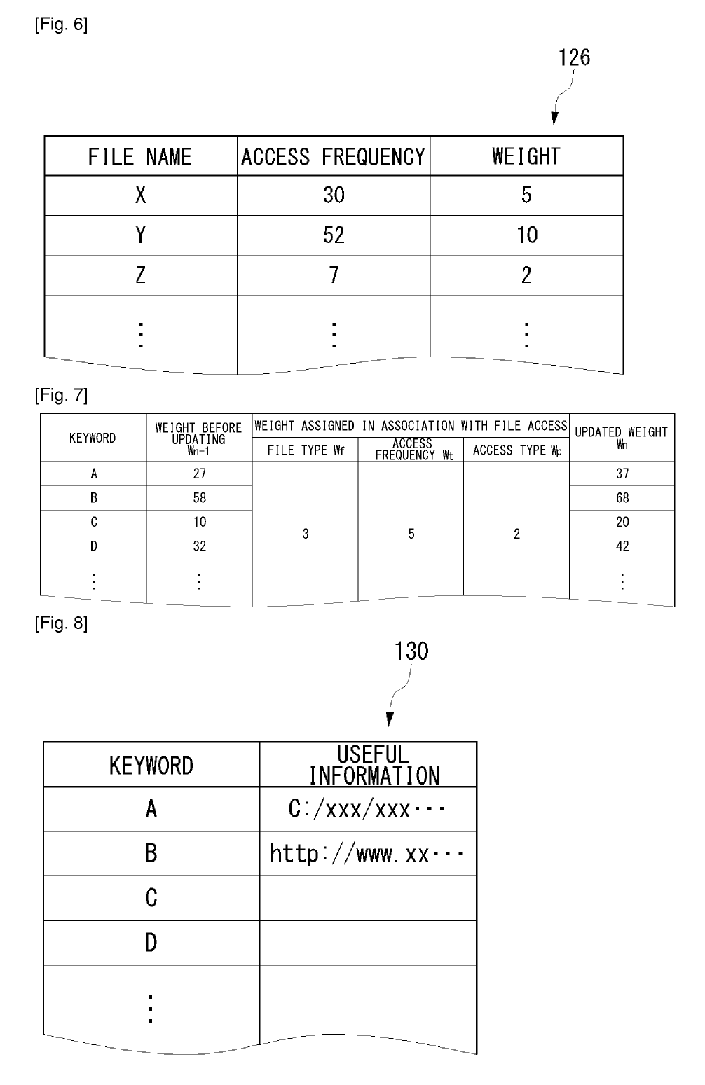

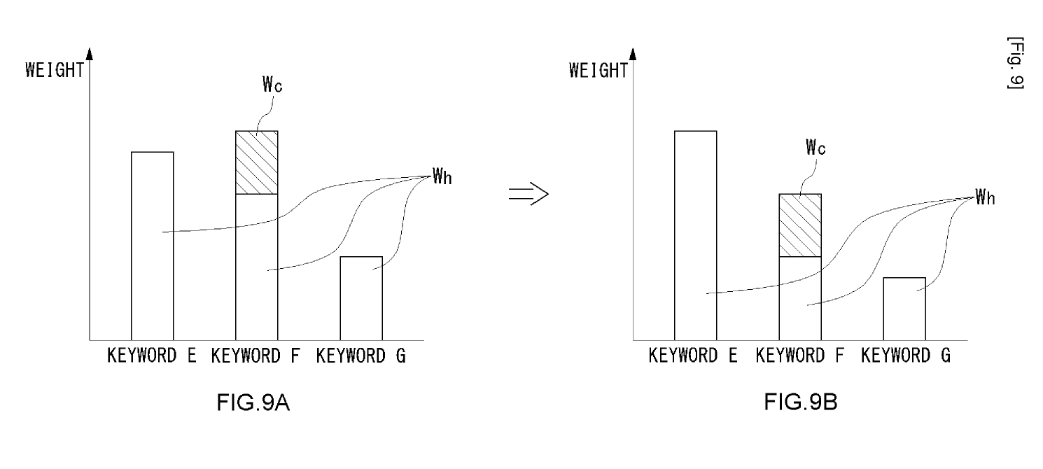

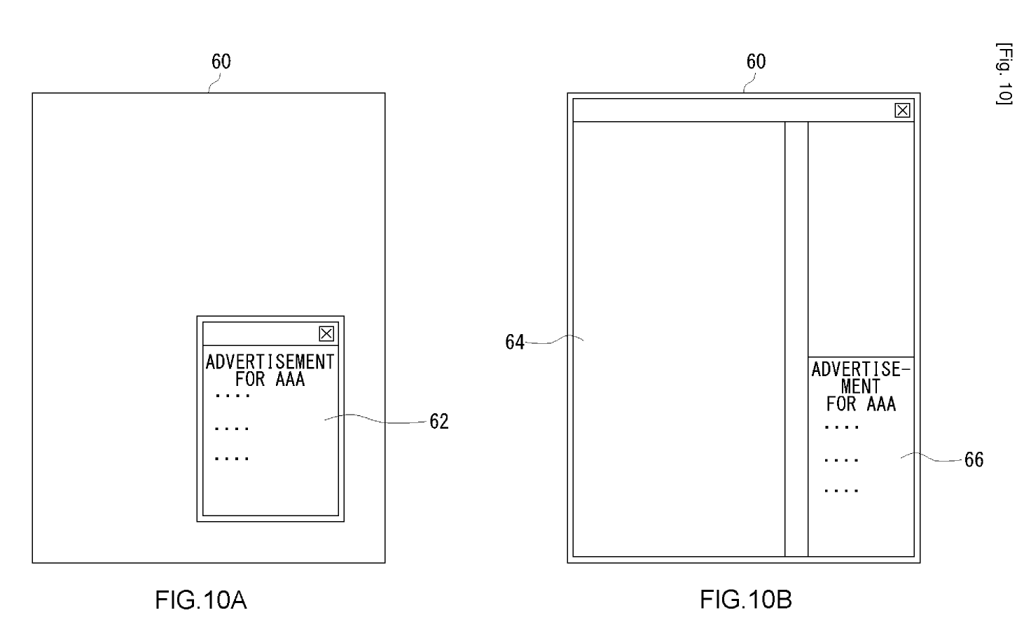

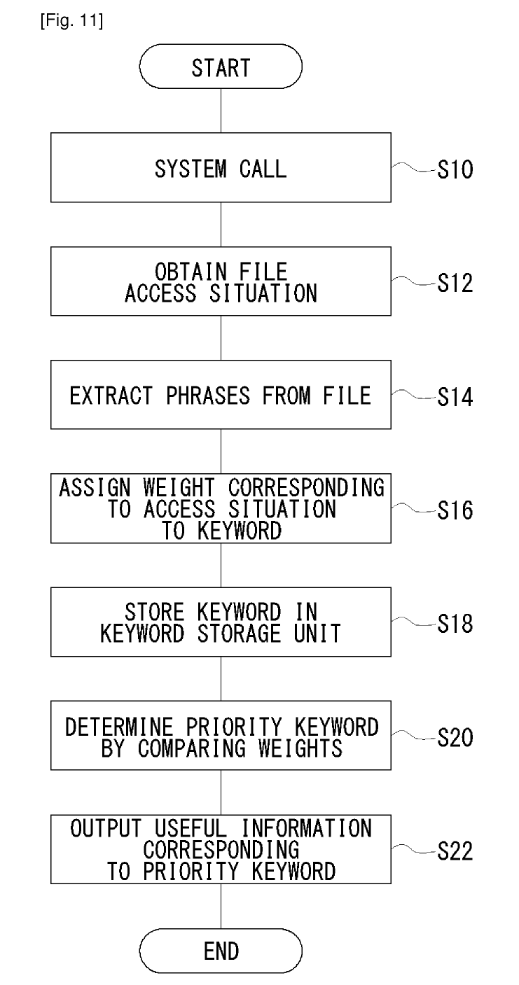

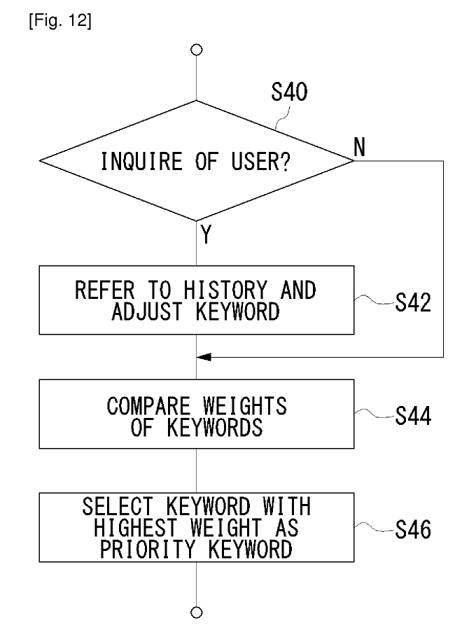

### BRIEF DESCRIPTION OF THE DRAWINGS

[FIG. 1] FIG. 1 shows the entire configuration of a network system including a portable information device provided with an information display function according to an embodiment.

[FIG. 2] FIG. 2 shows the hardware configuration of the portable information device.

[FIG. 3] FIG. 3 shows the configuration of an information display unit, which is a part of the portable information device related to information display function according to the embodiment.

[FIG. 4] FIG. 4 shows an example of a file-type table.

[FIG. 5] FIG. 5 shows an example of an access type table.

[FIG. 6] FIG. 6 shows an example of an access frequency table.

[FIG. 7] FIG. 7 shows a weighting process by a score processor.

[FIG. 8] FIG. 8 shows an example of keywords and useful information recorded in a useful information storage unit.

[FIG. 9] FIGS. 9A and 9B show adjustment of keywords by an information selector.

[FIG. 10] FIGS. 10A and 10B show screens displaying useful information.

[FIG. 11] FIG. 11 is a flow chart of the processing in the information display apparatus according to the embodiment, for presenting useful information in response to a system call.

[FIG. 12] FIG. 12 is a flow chart showing the detailed procedure for keyword weight adjustment performed by the information selector.

### EXPLANATION OF REFERENCE

10 portable information device, 12 server, 14 network, 100 information display unit, 102 file storage unit, 104 access processor, 106 phrase extractor, 108 image output unit, 110 keyword storage unit, 112 weight table, 114 weighting history table, 120 score processor, 122 file type table, 124 access type table, 126 access frequency table, 128 weight decreasing unit, 130 useful information storage unit, 150 information selector, 152 user configuration unit, 154 priority keyword adjusting unit

### BEST MODE FOR CARRYING OUT THE INVENTION

In one embodiment of the present invention, an operating system (OS) of a portable information device monitors access from an application program to a file, extracts a plurality of keywords from the file, and displays useful information such as an advertisement corresponding to a keyword on a screen of the portable information device. This enables deriving useful information suited to the interest of the user of the portable information device via keywords contained in the accessed file. A detailed description of the embodiment will now be given with reference to the attached drawings.

FIG. 1 shows the entire configuration of a network system including a portable information device 10 provided with an information display function according to this embodiment.

The portable information device 10 may be any hardware movable with the user, such as a laptop PC (personal computer), PDA, cellular phone, and car navigation device provided with communication functions. The portable information device 10 is connected by the user's operation to a network 14, such as a LAN and the Internet, via an access point 16 or a base station 18, and is capable of accessing a server 12 specified by a URL and of acquiring desired data

The server 12 provides the portable information device 10 with data such as text data, image data, audio data, video data, etc. via the network 14. The server may be a service entity on the Internet such as a web server. In that case, the invention may be implemented in various modes including: a mode embodied, for example, by a Common Gateway Interface (CGI) in which the server side takes care of the major processing functions; a mode embodied by, for example, a Java (registered trademark) applet in which the major processing functions are shifted to the client side; and a mode of Application Program Interface (API) type in which the main processing functions (e.g., Java applications) are distributed both to a server and a client.

The portable information device 10 is configured so that it can refer to and edit a file stored in an internal storage or a storage medium by the user's operation, even if the device does not access the network 14.

FIG. 2 shows the hardware configuration of the portable information device 10. The portable information device 10 is provided with a CPU 20, a main memory (RAM) 22, a ROM 24, an audio controller 26, a nonvolatile storage 32, a display controller 34, an input device 38, a communication controller 40, an external storage 42, and a GPS receiver 44. These are mutually connected via a bus 46.

The CPU 20 runs an operating system and controls the entire portable information device 10. The CPU 20 also reads into the main memory 22 a program and data from the ROM 24 or the recording medium loaded into the external storage 42, and performs various kinds of processing accordingly. The main memory 22 serves as a temporary storage and a work area which is needed when the CPU 20 executes the program, and as an area which stores various kinds of data required for program execution. The ROM 24 is a read-only storage which stores a computer program and data processed by the CPU 20.

The audio controller 26 is provided in the portable information device such as a cellular phone provided with a telephone function and is connected with a microphone 28 and a loudspeaker 30 for audio input output control. The nonvolatile storage 32 is a storage capable of retaining the memory content even after power OFF, and may be a hard disk drive or a semiconductor memory such as a flash memory.

The display controller 34 generate a video signal for displaying the data drawn by the CPU in a frame buffer (not shown) on a display 36 provided in the portable information device 10.

The input device 38 is a device for the user to provide directions for operation to the portable information device 10. The input device 38 may be any device suited to the terminal. For example, the device may be: keys; a pointing device like a trackpad; buttons; and a touch panel provided on the surface of the display 36.

The communication controller 40 controls communication of sound and data by various communication schemes. The data communication scheme may be wireless LAN such as IEEE802.1b/g, infrared communication, or data communication such as packet communication. The portable information device 10 may be connected to the network 14 using a cable.

The external storage 42 is a drive device which uses a removable recording medium. The recording medium may be a magnetic disk, an optical disk, a magneto-optical disc, or a semiconductor memory.

The GPS receiver 44 is a device which locates the portable information device based on radio wave from a satellite. Since the constituting elements described above are all well known, a description of further details will be omitted.

Characteristically, a substantial amount of data in applications like e-mail and web browsing is temporarily stored in a file. Files for received mail and cache files of a browser, etc. are referred to repeatedly. Thus, when the user refers to a file accessed frequently, it will be very useful to present to the user an advertisement or news relevant to the file, update information of a related website, etc. In this background, the present embodiment provides a framework of showing the user useful information using the status of access to a file or a file type.

FIG. 3 shows the configuration of an information display unit 100, which is a part of the portable information device 10, wherein presentation of information is based on a file operation. The configuration is implemented in hardware by any CPU of a computer, a memory or other LSI's, and in software by a program or the like loaded into the memory. FIG. 3 depicts functional blocks implemented by the cooperation of hardware and software. Therefore, it will be obvious to those skilled in the art that the functional blocks may be implemented in a variety of manners including hardware only, software only, or a combination thereof.

Preferably, the information display unit 100 according to this embodiment is implemented by a part of an operating system. An operating system has various functions, such as process control, memory management, device management, and GUI. Of those functions implemented by the combination, FIG. 3 illustrates only those which pertain to this embodiment. The portion enclosed with the dashed line in FIG. 3 shows the functional block added to the operating system for realization of this embodiment. Those functions provided in a common operating system are of course provided even if they are not shown in FIG. 3.

Before explaining each functional block in detail, the outline of the entire operation is explained. When a system call for file access is issued from an application program 90, an access processor 104 selects from a file storage unit 102 a file specified by the system call, and performs a file access. A phrase extractor 106 extracts a plurality of phrases from the file in accordance with a predetermined extraction rule. Keywords corresponding to the extracted phrase are selected from the keywords stored in a keyword storage unit 110. A score processor 120 assigns a weight to each selected keyword according to the situation of access to the file by the access processor 104. The information selector 150 receives the keywords assigned a weight from the score processor 120, and determines a keyword to which priority is assigned by the weight. Useful information associated with the priority keyword is selected from a useful information storage unit 130, and is displayed on the display 36 of the portable information device 10.

Details of the operation and configuration of the functional blocks will now be described.

The file storage unit 102 holds a plurality of files read by various kinds of applications. For example, an HTML file, a document file, a PDF file, a presentation file, a spreadsheet, an image file, and a video file is included.

When a system call for file access is issued from any of a plurality of application programs 90, the access processor 104 selects from the file storage unit 102 the file specified by the system call. The processor then accesses the file designated by the system call. The file access process specified by a system call includes opening and closing, writing, deletion, etc. of a file. As a result of the file access process by the access processor 104, a screen showing the execution of the file by the application program is displayed on the display 36 of the portable information device 10, or a screen currently displayed is closed.

The phrase extractor 106 acquires the file which is designated by the system call and which is the target of file access by the access processor 104. The extractor then extracts a plurality of phrases from the text data contained in the file. The extraction is performed in accordance with a predefined extraction rule. For example, after performing well-known morphological analysis on the text data and dividing the data into morphemes, the frequency of occurrence of each phrase within the file is counted. The unit then extracts a characteristic phrase. The term “characteristic phrase” refers to a phrase by which a part of information (e.g., the content and property of a file, or the person to which the file is directed) can be estimated. A predetermined number of those phrases with the highest frequency of occurrence may be designated as characteristic phrases. Alternatively, characteristic phrases may be extracted by a well-known Term Frequency (TF) method whereby a weight based on the frequency of occurrence within a file is applied. Still alternatively, characteristic phrases may be extracted by an Inverse Document Frequency (IDF) method whereby data for phrases with higher frequency of occurrence in ordinary sentences are registered in the phrase extractor 106, so that phrases that appear frequently in any sentences are assigned a low weight, and phrases that are unique to the sentence are extracted so as to highlight its uniqueness. The TF/IDF method, which is a combination of the TF method and the IDF method, may be used.

A large number of keywords of low value will be held in the keyword storage unit 110 if the phrases extracted by the phrase extractor 106 are too many. Therefore, it is preferable to ensure that ten or fewer characteristic phrases are extracted. However, the number of characteristic phrases extracted from a single file is not limited. Any number of phrases can be extracted.

The keyword storage unit 110 holds weights assigned to the keywords. The unit may hold a keyword group fixedly defined from the beginning, or phrases extracted as characteristic phrases by the phrase extractor 106 may be added as a new keywords as they occur. The keyword storage unit 110 is provided with the following: a weight table 112 in which keywords and weights assigned to them are associated and stored; and a weighting history table 114 in which the history in which weights are assigned to the keywords by the score processor 120 mentioned later is stored.

The score processor 120 acquires from the keyword storage unit 110 keywords corresponding to the characteristic phrases extracted by the phrase extractor 106 from the file which was the target of file access. The weight according to the situation of access by the access processor 104 to the file and the weight corresponding to the type of the file are added to the weight assigned to each keyword and acquired from the keyword storage unit 110. These keywords assigned a weight are recorded in the keyword storage unit 110.

In this specification, the term “access situation” generically refers to the mode of access to the file by the access processor 104. More specifically, “access frequency” and “access type” are referred to. Access frequency is defined as a total number of times of access to each file by the access processor 104. Access type corresponds to the type of file access specified by the system call, and, more specifically, indicates opening, closing, rewriting, etc. of a file. An access situation is not restricted to these, and a weight may be set up according to access frequency so that a special weight may be assigned when, for example, a file is repeatedly accessed in a predetermined period of time.

In order to assign a weight according to access situation or file type, the score processor 120 is provided with a plurality of tables.

A file-type table 122 defines a weight for each file type. FIG. 4 shows an example of a file-type table. Different weights are applied according to the file type. This is suitably determined according to the degree of interest to the user in the file type. For example, FIG. 4 shows that a weight higher than those of other files is defined according to a criteria “an HTML cache file is of comparatively high interest.” When an access by the access processor 104 occurs, the score processor 120 acquires the extension of a file so as to determine a file type, and determines a weight according to the file-type table 122.

An access type table 124 defines the weight according to the type of access by the access processor 104. FIG. 5 shows an example of an access type table. It is preferable to assign a comparatively high weight to file access considered to be of high interest to the user. For example, since a keyword contained in a file which is updated is considered to be of high interest to the user, a weight higher than that of access for opening or closing is defined.

An access frequency table 126 defines a weight for each frequency of access to each file. FIG. 6 shows an example of an access frequency table. As illustrated, the number of times of file access is recorded in the access frequency table 126 for each file stored in the file storage unit 102. The score processor 120 acquires the file name of a file stored in the file storage unit 102 when an access by the access processor 104 occurs, or according to a predetermined schedule. Alternatively, whenever the access processor 104 accesses a file stored in the file storage unit 102, the processor 104 informs the score processor 120 of the access. The score processor 120 increments the access frequency corresponding to the file name in the access frequency table 126, in response to information from the access processor 104.

The access frequency may itself represent a weight. In that case, however, it is difficult to maintain the balance with a weight assigned in accordance with the file type and the access type. Thus, the score processor 120 may hold two or more classes with respect to access frequency, and may assign a predetermined weight whenever the access frequency exceeds a threshold in each class. For example, in the example of FIG. 6, the weight 1 may be assigned if the access frequency is 0-5, the weight 2 may be assigned if the frequency is 5-10, the weight 5 may be assigned if the frequency is 10-50, and the weight 10 is assigned if the frequency is 50 or more.

In another embodiment, the weight may be defined in the form of a mathematical function so that the weight is determined with frequency of access as a variable. For example, given that the access frequency is indicated by t, the weight by wf, and the function returning an integer by INT, the weight may be defined such that wt=INT(t1/2).

The score processor 120 refers to the tables 122-126, calculates a sum of weights corresponding to the file type, access type and access frequency of the file accessed by the access processor 104, and adds the sum to the weight assigned to the keyword and acquired from the keyword storage unit 110. That is, given that the weights corresponding to the file type, access type and access frequency are indicated by wf, wp and wt, and the previous value of the sum total of the weights assigned to the keyword is indicated by Wn−1, and the current value by Wn, the following expression holds.

Wn=Wn−1+(wf+wp+wt)

This process will be explained with reference to FIG. 7. It will be assumed that the weights Wn−1 assigned to keywords A-D acquired from the keyword storage unit 110 are 27, 58, 10, and 32, respectively. In response to the file access by the access processor 104, the access processor 104 determines, with reference to the tables 122-126, the weights such that the weight corresponding to the file type wf=3, the weight corresponding to the access type wp=2, and the weight corresponding to the access frequency wt=2. The sum, wf+wp+wt (=10), is then added to the weight Wn−1 so as to update the weights Wn assigned to the keywords A-D.

Thus, one of the features of this embodiment is that the weight assigned to a file itself or the type of access to the file is assigned to a keyword extracted from the file. Only one or two of the above-mentioned three weights may be added to a keyword.

The score processor 120 may be provided with a weight decreasing unit 128 which decreases the weight assigned to a keyword with the passage of time. Specifically, the date on which the score processor 120 assigned a weight last time to each keyword is recorded in the weighting history table 114. When the score processor 120 acquires a keyword from the keyword storage unit 110, the processor searches the weighting history table 114 for a corresponding date. The weight decreasing unit 128 decreases the weight Wn−1 currently recorded in the weight table according to the date in the weighting history. For example, the weight Wn−1 is decreased by 5% if the date on which the weight is assigned most recently is one week before, 10% if the date is one month before, and 20% if the date is three months before. Alternatively, the weight Wn−1 may be decreased using a predetermined mathematical formula. For example, given that the current date is indicated by d1, the date recorded in the history is indicated by d2, and the function yielding a smaller value as the number of days d is increased is indicated by F(d), the weight is defined such that Wn−1=F(d1−d2)*Wn−1.

In this way, the keyword which was previously assigned a larger weight but which is not extracted by the phrase extractor 106 recently will be assigned a reduced weight. Therefore, the weight Wn ultimately output from the score processor 120 is less affected than otherwise. Therefore, useful information more suited to the interest of the user at present is more likely to be selected by the information selector 150.

Instead of decreasing the weight by the score processor 120, the keyword storage unit 110 may decrease the weight currently recorded in the weight table 112. Specifically, the keyword storage unit 110 performs matching between the keywords in the weighting history table 114 and the keywords in the weight table 112 at predetermined intervals, and determines the date on which each keyword is weighted most recently. The unit decreases the weight currently recorded in the weight table 112 in accordance with the method mentioned above, and records the decreased weight in the weight table 112 again. In this case, the score processor 120 merely has to acquire keywords corresponding to the phrases extracted by the phrase extractor 106 from the keyword storage unit 110, and the weight decreasing unit 128 becomes unnecessary.

In another embodiment, the score processor 120 or the keyword storage unit 110 may decrease the weight assigned to a keyword according to the progress of the days after the keyword was first recorded in the weight table 112. In this case, the keyword storage unit 110 needs to be provided with a keyword registration history table which records the date on which the keywords were first registered, instead of weighting history table 114.

Referring back to FIG. 3, the useful information storage unit 130 stores a plurality of items of useful information to be provided to the user, in association with keywords relevant to the content of the information. The useful information may be, for example, an advertisement, the URL of a web page or a blog, a help and news. FIG. 8 shows an example of keywords and useful information recorded in the useful information storage unit 130.

If the keyword stored in the keyword storage unit 110 is a fixed one, useful information corresponding to keywords may be stored in the portable information device at the time of shipping. Alternatively, updated useful information may be acquired periodically from the server 12 accessed by the portable information device 10. When phrases extracted by the phrase extractor 106 are added to the keyword storage unit 110, combinations of a large number of keywords and useful information may be stored in the server 12, so that, when a new keyword is added, the portable information device 10 may access the server 12 to acquire the useful information corresponding to the new keyword. Since the freshness of information counts in presenting an advertisement, news, website information, etc. as useful information, it is preferred to download useful information from a server as necessary.

Returning back to FIG. 3, the information selector 150 receives from the score processor 120 a plurality of keywords to which a weight is added according to the situation of access to a file, and compares the weights assigned to the keywords with reference to the weight table 112 in the keyword storage unit 110. And the keyword prioritized by the weight is determined, and the useful information associated with the priority keyword is selected from the useful information storage unit 130. The selected useful information is delivered to the image output unit 108.

Of the keywords received from the score processor 120, the keyword with the highest weight is defined as a priority keyword. The useful information may be prevented from being displayed until the number of keywords assigned a weight reaches a certain value, since presenting useful information in an initial stage where the number of keywords assigned a weight is still small in the weight table 112 will result in the same useful information being always displayed.

The user of the portable information device may access a specific file quite frequently and want the related useful information to continue to be shown while accessing the file. In this respect, the information selector 150 may be provided with a priority keyword adjusting unit 154 which applies adjustment so that the keyword to which a weight equal to or larger than a predetermined value is continuously assigned for a prescribed period of time or longer may be further prioritized.

With reference to FIG. 9, the method of adjustment by the priority keyword adjusting unit 154 will be explained. Upon receiving a plurality of keywords from the score processor 120, the priority keyword adjusting unit 154 refers to the weighting history table 114 in the keyword storage unit 110, so as to determine whether there is a keyword (hereinafter, referred to as a “keyword of note”) to which a weight equal to larger than a predetermined value (e.g, equal to or larger than 5) is assigned for a predetermined period of time (e.g. one week) or longer. When there is a keyword of note, the priority keyword adjusting unit 154 compares the weights assigned to a plurality of keywords, and adds an adjustment weight wc only to the weight wh of the keyword of note stored in the weight table. Referring to FIG. 9A, an adjustment weight wc is added to the keyword of note F.

A keyword contained in a file which came to be used frequently comparatively recently is less likely to be selected as a priority keyword since such a keyword is not assigned a weight accumulated over a long period of time than a keyword contained in a file which is used for some time. Therefore, the former keyword is less likely to be selected as a priority keyword as a result of weight comparison without adjustment. However, when such a keyword is determined to be a keyword of note by the priority keyword adjusting unit 154, the keyword is more likely to be selected as a priority keyword than other keywords since an extra, adjustment weight wc is added to the keyword of note. Therefore, the likelihood of presenting useful information of great relevance to the file currently being processed is increased.

As mentioned above, the weight wh assigned by the keyword storage unit 110 or the score processor 120 to each keyword decreases gradually with the passage of time. Thus, even when a keyword is determined to be a keyword of note and applied an adjustment weight wc by the priority keyword adjusting unit 154, the keyword will no longer be selected as a priority keyword if the keyword of note does not appear in subsequently accessed files and, as a result, the total weight becomes smaller than that of other keywords. That is, a situation is avoided in which the same useful information, associated with a keyword once determined to be a keyword of note, continues to be displayed.

The above-described adjustment of weighting of a keyword may appear to some users that information presented is insufficient. Thus, the information selector 150 may be provided with a user configuration unit 152 which inquires of the user whether weighting should be adjusted by the priority keyword adjusting unit 154, and which allows adjustment to be performed only when an affirmative reply is received.

Instead of storing keywords and useful information in one-to-one correspondence, the useful information storage unit 130 may store a combination of a plurality of keywords and useful information in association with each other. In this case, the information selector 150 determines a predetermined number of a plurality of keywords received from the score processor 120 as priority keywords, and selects useful information corresponding to the combination of priority keywords. In order to select useful information from a plurality of keywords, the well-known vector search technique may be used. By selecting useful information based on a plurality of keywords, the probability that the useful information that matches the user's interest will be shown becomes high.

As shown in FIG. 10A, the image output unit 108 displays the useful information outputted from the information selector 150 in a separate window 62 on the screen 60 of the display. Alternatively, as shown in FIG. 10B, when there is an area in which to display the useful information in an image created by an application program, the image output unit 108 delivers the information to the application program and allows the program to create an image 64 including useful information 66.

FIG. 11 is a flow chart of the processing in the information display apparatus according to this embodiment, for presenting useful information in response to a system call. When a system call is issued from an application program to an operating system (S10), the access processor 104 processes the file access specified by the system call. The score processor 120 acquires information about the situation of file access by the access processor 104 and about the accessed file type (S12). The phrase extractor 106 acquires the file accessed by the access processor 104, and extracts phrases from the text data contained in the file in accordance with a predetermined extraction rule (S14).

The score processor 120 acquires keywords that match the phrases extracted by the phrase extractor 106 from the keyword storage unit 110, and adds a weight to each keyword according to the access situation (S16). Keywords assigned a weight are stored in the keyword storage unit 110 (S18). Along with this, the weighted keywords are delivered to the information selector 150. The information selector 150 compares the weights of the keywords by referring to the weight table 112, and determines priority keywords (S20). The information selector 150 acquires useful information associated with the priority keywords from the useful information storage unit 130, and outputs the information (S22). Of the above-mentioned steps, steps S14-S20 are performed in the background.

FIG. 12 is a flow chart showing the detailed procedure of S20 performed in a case of carrying out weight adjustment of keywords by the information selector 150. Upon receiving a plurality of weighted keywords from the score processor 120, the user configuration unit 152 refers to the result of inquiring of the user whether to adjust keywords (S40). When the user chooses not to make keyword adjustment (N in S40), S42 is skipped. When the user chooses to make keyword adjustment (Y in S40), the priority keyword adjustment unit 154 refers to the weighting history table 114 and selects a keyword of note to which a weight of a predetermined value or larger is assigned for a predetermined period of time or longer. The unit 154 adds an adjustment weight wc to the weight wh of the keyword of note stored in the weighting table 112 (S42). The priority keyword adjusting unit 154 compares the weights of the keywords (S44) and selects the keyword with the maximum weight as a priority keyword (S46).

As has been described, according to the present embodiment, keywords are extracted from a file subject to file access. The keywords are weighted according to the access situation (e.g., access frequency or access type) or file type. Useful information associated with the keyword prioritized by the weight is displayed on a portable information device. By weighting keywords in accordance with the file type and the situation of access to the file, weighting which allows for the history of operation by the user of the portable information device is performed, enabling displaying useful information more suited to the user's interest.

By allowing the information selector to select useful information corresponding to keywords assigned a large weight, the following problem occurs. For example, when the user automatically and periodically visits a web site, the HTML file of the site recorded in the history will be accessed repeatedly. When the tendency of access to files becomes relatively unchanged as in this case, keywords scored high as a result of weight comparison in the information selector become fixed, with the result that the same useful information continue to be displayed. In this embodiment, the weight corresponding to the file type and situation of access to a file is decreased with the passage of time. Accordingly, the aforementioned situation is avoided.

As mentioned before, the information display unit according to this embodiment is preferably built in the portable information device as a function of an operating system. By being incorporated as a function of an operating system, the situation of access to an application can be easily kept track of by using a system call, and the weight corresponding to the access situation can be set up for each file. Thus, by implementing the embodiment by an operating system without using an application program, weighting can be performed for any file called from any application program executed on the operating system. Therefore, since keywords can be extracted from a variety of files, accuracy in presenting useful information that matches the user's interest is improved. However, a form of implementation, in which a part of the aforementioned functional blocks is executed by another application, is not excluded.

Given above is an explanation of the invention based on the embodiment. The embodiment is intended to be illustrative only and it will be obvious to those skilled in the art that various modifications to constituting elements and processes could be developed and that such modifications are also within the scope of the present invention.

When extracting phrases by the phrase extractor 106, different extraction rules may be used according to the file type.

In this embodiment, the weight assigned to a keyword by the score processor is described as being decreased with the passage of time. Conversely, the weight assigned to a keyword may be fixed. For example, the weight assigned to an extremely important file type may not be decreased with the passage of time. Thus, some of the weights, which correspond to the file type, access frequency and access type, may be time-dependent and some may be fixed.

In the embodiment, the score processor is described as increasing the weight assigned to a keyword with an increase in the access frequency. Conversely, the weight assigned to a keyword may be decreased as the access frequency increases. This ensures that the weight assigned to a keyword hardly increases even if a frequently accessed file is additionally accessed. The likelihood of a frequently-used keyword being selected by the information selector as a priority keyword is reduced.

The useful information storage unit 130 may be located on the server 12 side. In this case, after comparing the weights assigned to a plurality of keywords and determining priority keywords, the information selector 150 transmits priority keywords to the server 12. The server 12 transmits the useful information corresponding to the received priority keywords to the portable information device 10.

Alternatively, both the information selector 150 and the useful information storage unit 130 may be located on the server 12 side. In this case, the score processor 120 transmits the weighted keywords to the server 12. The information selector 150 determines priority keywords as in the above-mentioned embodiment, selects from the useful information storage unit 130 the useful information associated with the priority keywords, and transmits the useful information to the portable information device 10.

Files accessed by the access processor 104 may not be located in the file storage unit 102 but on a network. For example, the access processor 104 may access a shortcut file.

In this embodiment, the information presenting apparatus according to the present invention is described as being implemented in a portable information device such as a cell phone, a PDA, a vehicle navigation device, etc. provided with data communication functions. The inventive apparatus may of course be implemented in desktop hardware such as a desktop PC.

### INDUSTRIAL APPLICABILITY

According to the present invention, the situation of access to files by an application program is monitored so that information relevant to the accessed file is presented to the user.

1. An information display apparatus comprising:
a file storage unit which stores a plurality of files;
a keyword storage unit which stores a plurality of keywords;
a phrase extractor which, when a system call for file access is issued by one of a plurality of application programs, extracts a plurality of phrases from the file subjected to the file access, in accordance with a predetermined extraction rule;
a score processor which weights a keyword that matches a phrase extracted from the file subjected to the file access, in accordance with the type of the file, and records the weighted keyword in the keyword storage unit;
a useful information storage unit which stores a plurality of items of useful information to be presented to the user, in association with keywords relevant to the content of the useful information; and
an information selector which, when a plurality of phrases are extracted from the file subjected to the file access, refers to weights recorded in association with keywords that match the plurality of phrases, and selects and displays on a screen useful information associated with a keyword prioritized by a weight.

2. The information display apparatus according to claim 1, wherein
the score processor determines the weight according to the frequency of access to the file.

3. The information display apparatus according to claim 1, wherein
the score processor determines the weight according to the type of access to the file.

4. The information display apparatus according to claim 1, wherein the score processor decreases the weight assigned to the keyword with the passage of time.

5. The information display apparatus according to claim 1, wherein
the information selector makes adjustment so that the keyword to which a weight equal to or larger than a predetermined value is continuously assigned for a prescribed period of time or longer is further prioritized.

6. The information display apparatus according to claim 5, wherein
the information selector inquires of the user whether weighting should be adjusted, and allows adjustment to be performed only when an affirmative reply is received.

7. The information display apparatus according to claim 1, wherein
the score processor determines the weight according to the type of the file.

8. (canceled)

9. An information display program product embodied on a computer-readable storage medium comprising:
an access processing module which, when a system call for file access is issued by one of a plurality of application programs, selects, from a file storage unit which stores a plurality of files, a file designated by the system call as a target of the file access, and processes the file access designated by the system call;
a phrase extracting module which extracts a plurality of phrases from the file subjected to the file access, in accordance with a predetermined extraction rule;
a score processing module which weights a keyword that matches a phrase extracted from the file subjected to the file access, in accordance with the situation of access by the access processing module to the file, and records the weighted keyword in a keyword storage unit which stores a plurality of keywords;
an information selecting module which, when a plurality of phrases are extracted from the file subjected to the file access, refers to weights recorded in association with keywords that match the plurality of phrases, and selects and displays on a screen useful information associated with a keyword prioritized by a weight, the selection being done from a useful information storage unit which stores a plurality of items of useful information to be presented to the user, in association with keywords relevant to the content of the useful information.

10. A server-client system for displaying useful information in a client terminal, comprising:
a client terminal and a server,
the client terminal comprising:
a file storage unit which stores a plurality of files;
an access processor which, when a system call for file access is issued by one of a plurality of application programs, selects, from the file storage unit, a file designated by the system call as a target of the file access, and processes the file access designated by the system call;
a keyword storage unit which stores a plurality of keywords;
a phrase extractor which extracts a plurality of phrases from the file subjected to the file access, in accordance with a predetermined extraction rule;
a score processor which weights a keyword that matches a phrase extracted from the file subjected to the file access, in accordance with the situation of access by the access processor to the file, and records the weighted keyword in the keyword storage unit; and
an information selector which, when a plurality of phrases are extracted from the file subjected to the file access, refers to weights recorded in association with keywords that match the plurality of phrases, determines a keyword prioritized by the weight, and transmits the determined keyword to the server; the server comprising:
a useful information storage unit which stores a plurality of items of useful information to be presented to the user, in association with keywords relevant to the content of the useful information, wherein the server selects the useful information corresponding to the keyword received from the client terminal from the useful information storage unit, and transmits the selected useful information to the client terminal.

11. A server-client system for displaying useful information in a client terminal, comprising:
a client terminal and a server,
the client terminal comprising:
a file storage unit which stores a plurality of files;
an access processor which, when a system call for file access is issued by one of a plurality of application programs, selects, from the file storage unit, a file designated by the system call as a target of file access, and processes the file access designated by the system call;
a keyword storage unit which stores a plurality of keywords;
a phrase extractor which extracts a plurality of phrases from the file subjected to the file access, in accordance with a predetermined extraction rule; and
a score processor which weights a keyword that matches a phrase extracted from the file subjected to the file access, in accordance with the situation of access by the access processor to the file, records the weighted keyword in the keyword storage unit, and transmits the weighted keyword to the server; the server comprising:
a useful information storage unit which stores a plurality of items of useful information to be presented to the user, in association with keywords relevant to the content of the useful information; and
an information selector which receives the weighted keyword from the client terminal, selects the useful information corresponding to the keyword prioritized by the weight, and transmits the selected useful information to the client terminal.

12. The information display apparatus according to claim 1, further comprising an access processor which, when a system call for file access is issued by one of a plurality of application programs, selects a file designated by the system call as a target of the file access from the file storage unit, and processes the file access designated by the system call;
wherein the score processor weights a keyword that matches a phrase extracted from the file subjected to the file access in accordance with the situation of access by the access processor to the file.

13. An information display method comprising:
storing a plurality of files in a memory;
storing a plurality of keywords in the memory;
when a system call for file access is issued by one of a plurality of application programs, extracting a plurality of phrases from the file subjected to the file access, in accordance with a predetermined extraction rule;
weighing a keyword that matches a phrase extracted from the file subjected to the file access, in accordance with the type of the file;
recording the weighed keyword in the memory;
storing a plurality of items of useful information to be presented to the user, in association with keywords relevant to the content of the useful information; and
when a plurality of phrases are extracted from the file subjected to the file access, referring to weights recorded in association with keywords that match the plurality of phrases; and
selecting and displaying on a screen useful information associated with a keyword prioritized by a weight.

14. The information display method according to claim 13, further comprising determining the weight according to the frequency of access to the file by the access processor.

15. The information display method according to claim 13, further comprising determining the weight according to the type of access to the file.

16. The information display method according to claim 13, further comprising decreasing the weight assigned to the keyword with the passage of time.

17. The information display method according to claim 13, further comprising making adjustment so that the keyword to which a weight equal to or larger than a predetermined value is continuously assigned for a prescribed period of time or longer is further prioritized.

18. The information display method according to claim 17, further comprising inquiring of the user whether weighting should be adjusted, and allowing adjustment to be performed only when an affirmative reply is received.

19. The information display method according to claim 13, further comprising determining the weight according to the type of the file.

20. The information display method according to claim 13, further comprising, when a system call for file access is issued by one of a plurality of application programs, selecting a file designated by the system call as a target of the file access;
processing the file access designated by the system call; and
weighing a keyword that matches a phrase extracted from the file subjected to the file access in accordance with the situation of access to the file.
